(19) United States
(12) Patent Application Publication
(10) Pub. No.: US 2012/0020378 A1
(43) Pub. Date: Jan. 26, 2012

(54) WIDELY TUNABLE OPTICAL PARAMETRIC GENERATOR HAVING NARROW BANDWIDTH FIELD

(76) Inventor: Steven X. Li, Ellicott City, MD (US)

(21) Appl. No.: 12/840,787

(22) Filed: Jul. 21, 2010

(51) Int. Cl. H01S 3/11; H01S 3/10

(52) U.S. Cl. 372/10; 372/21

(57) ABSTRACT

Systems, methods and apparatus are provided through which in some implementations mode selection and wavelength tuning of optical parametric generation is achieved through intrinsic nonlinear crystal dispersion.

### FIELD

This disclosure relates generally to lasers, and more particularly to tunable lasers.

### BACKGROUND

Optical parametric generators (OPGs) are efficient generators of tunable coherent radiation in near- and mid-infrared regions. In the last few years, considerable progress has been achieved in the field of infrared pulse generation through OPG and optical parametric amplifiers (OPAs). These techniques possess very broad wavelength tunability. However, the radiation generated by OPG has broad linewidth. The broad bandwidth limitation has been a serious problem for OPGs, which greatly limits applications of OPGs. The broad bandwidth limitation of OPGs is caused by parametric generation in OPGs starting from broad parametric fluorescence.

In response, narrow-bandwidth seeding with a CW Distributed Feedback (DFB) laser was developed to overcome problems associated with broad bandwidth limitations and to preserve the good spectral quality of laser pulses. The tunability of narrow-bandwidth seeded OPGs has been insignificant and has amounted to less than 2 nm near 1.5 um; multiple DFB lasers are required for wide wavelength tuning. In addition the narrow-bandwidth seeded OPGs have higher thresholds and lower conversion efficiencies.

For the reasons stated above, and for other reasons stated below which will become apparent to those skilled in the art upon reading and understanding the present specification, there is a need in the art to generate narrow bandwidth output by an OPG without injection seeding.

### BRIEF DESCRIPTION

The above-mentioned shortcomings, disadvantages and problems are addressed herein, which will be understood by reading and studying the following specification.

In some aspects, an apparatus includes an optical pump, a pump focus lens assembly operably coupled to the optical pump, an optical parametric generator having a nonlinear crystal, the optical parametric generator being operably coupled to the pump focus lens assembly, a filter lens operably coupled to the optical parametric generator, and an optical parametric amplifier operably coupled to the filter lens.

In some aspects, an apparatus includes a high repetition rate, single frequency, q-switched laser, an uncoated periodically poled lithium niobate optical parametric generator having parallel polished end surfaces, the generator being operable to generate very narrow linewidth output just about a threshold of the optical parametric generator, a pump focus lens assembly being operable to adjust the threshold of the optical parametric generator, the optical parametric generator being operably coupled to an anti-reflective coated periodically poled lithium niobate optical parametric amplifier, and a filter lens that is operable to focus the beam of the high repetition rate, single frequency, q-switched laser, an idler beam and a signal beam into the optical parametric amplifier.

In some aspects, a method to generate laser energy includes generating light wave energy, a single-frequency pulsed light optical pump toward an optical parametric generator having periodic poled nonlinear crystal materials, adjusting a pump threshold of the generated light wave energy, by a pump focus lens assembly, and focusing the adjusted pump beam into an optical parametric amplifier, the optical parametric amplifier having periodic poled nonlinear crystal materials, the focusing being performed by a filter lens, that does not include injection seeding.

Apparatus, systems, and methods of varying scope are described herein. In addition to the aspects and advantages described in this Brief Description, further aspects and advantages will become apparent by reference to the drawings and by reading the detailed description that follows.

### BRIEF DESCRIPTION OF THE DRAWINGS

FIG. 1 is a cross section block diagram of an overview of a system to generate laser energy, according to an implementation;

FIG. 2 is a diagram of coincident modes, idler modes and signal modes, according to an implementation; and

FIG. 3 is a flowchart of a method to generate laser energy, according to an implementation.

### DETAILED DESCRIPTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into five sections. In the first section, a system level overview is described. In the second section, apparatus of implementations are described. In the third section, implementations of methods are described. In the fourth section, a conclusion of the detailed description is provided.

### System Level Overview

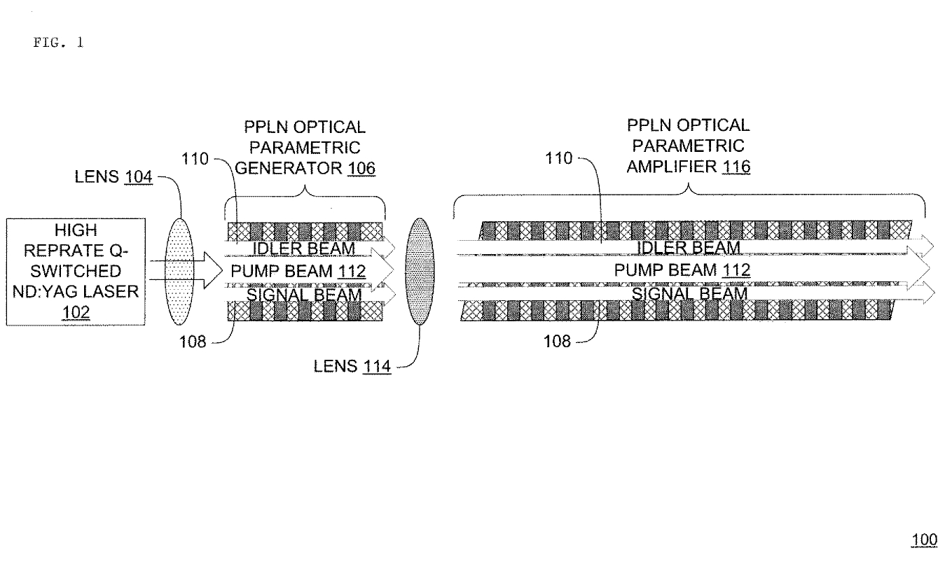

FIG. 1 is a cross section block diagram of an overview of a system 100 to generate laser energy, according to an implementation. System 100 provides narrow linewidth near- and mid-infrared wave with optical efficiency better than 50%.

System 100 includes a high repetition rate Q-switched, single frequency Nd:YAG laser 102, or other single-frequency pulsed light laser. Nd:YAG lasers are optically pumped using a flashlamp or laser diodes. Nd:YAG lasers are one of the most common types of laser, and are used for many different applications. In one example, the high repetition rate Q-switched Nd:YAG laser 102 produces 50 uJ in 3.5 ns at 5.5 KHz.

Nd:YAG lasers typically emit light with a wavelength of 1064 nm, in the infrared. However, there are also transitions near 940, 1120, 1320, and 1440 nm. Nd:YAG lasers operate in both pulsed and continuous mode. Pulsed Nd:YAG lasers are typically operated in the so called Q-switching mode: An optical switch is inserted in the laser cavity waiting for a maximum population inversion in the neodymium ions before the optical switch opens. Then the light wave can run through the cavity, depopulating the excited laser medium at maximum population inversion. In this Q-switched mode, output powers of 250 megawatts and pulse durations of 1 to 25 nanoseconds have been achieved. The high-intensity pulses may be efficiently frequency doubled to generate laser light at 532 nm, or higher harmonics at 355 and 266 nm.

Other common host materials for neodymium are: YLF (yttrium lithium fluoride, 1047 and 1053 nm), YVO4 (yttrium orthovanadate, 1064 nm), and glass. A particular host material is chosen in order to obtain a desired combination of optical, mechanical, and thermal properties. Nd:YAG lasers and variants are pumped either by flash lamps, continuous gas discharge lamps, or near-infrared laser diodes (DPSS lasers).

System 100 also includes a pump focus lens assembly 104 that is operably coupled to the high repetition rate, single frequency, Q-switched Nd:YAG laser 102.

System 100 also includes an optical parametric generator having a nonlinear crystal 106 that is operably coupled to the pump focus lens assembly 104. In some implementations, the nonlinear crystal is a periodically poled lithium niobate (PPLN). The chemical symbol of PPLN is LiNbO₃. LiNbO3 is an inexpensive material. Periodic poling of nonlinear crystal materials is a technique for obtaining quasi-phase matching of nonlinear interactions. Quasi-phase matching of nonlinear interactions involves a process which generates a periodic reversal of the domain orientation (domain inversion) in a nonlinear crystal, so that the sign of the nonlinear coefficient also changes. Other implementations of the nonlinear crystal include ferroelectric nonlinear crystal materials such as lithium tantalate (LiTaO3), potassium titanyl phosphate (KTP, KTiOPO4) and potassium titanyl arsenate (KTA, KTiOAsO4).

In some implementations, the PPLN is a partially reflective coated PPLN. In some implementations of the partially reflective coated PPLN, the amount of partial reflection is 14% for both a signal beam 108 and an idler beam 110. In some implementations, the PPLN is an uncoated PPLN. In some implementations, the PPLN has parallel polished front faces. Uncoated and partially reflective coated PPLN with parallel polished front faces has the effect of a feedback system that has a strong mode selection.

The periodically poled lithium niobate provides quasi-phase-matching (QPM) that compensates for the difference in phase velocity between the pump beam 112 and the harmonic wave of the pump beam 112 that is caused by intrinsic natural dispersion. In QPM, the pump beam 112 and the harmonic wave of the pump beam 112 have different phase velocities, and the pump beam 112 and the harmonic wave of the pump beam 112 shift π out of phase relative to one another over the coherence length. The sign of the nonlinear coefficient is reversed every coherence length, causing the local generated harmonic field to transfer power to the harmonic beam. By compensating for phase-velocity mismatch in this way, all elements of the crystal's nonlinear tensor can be accessed throughout the entire transparency range.

System 100 also includes a filter lens 114 that is operably coupled to the nonlinear crystal 106.

System 100 also includes an optical parametric amplifier 116 that is operably coupled to the filter lens 114. In some implementations, the optical parametric amplifier includes periodically poled lithium niobate. In some implementations, the periodically poled lithium niobate includes an anti-reflective (AR) coating. In some implementations, the periodically poled lithium niobate has angle polished front faces. In some implementations, the periodically poled lithium niobate has 5 degree angle polished front faces.

In one particular implementation, a short (e.g. 5 mm to 20 mm), uncoated PPLN optical parametric generator (OPG) 106 having a parallel polished surface is pumped by a high repetition rate, single frequency, q-switched laser 102. The uncoated front surface of the PPLN OPG 106 has a 14% reflection for both the signal beam 108 and the idler beam 110. The PPLN OPG 106 is operable to generate very narrow linewidth output just above a threshold. The threshold of the PPLN OPG can be adjusted by the pump focus lens assembly 104. The filter lens 114 is operable to focus the beam of the high repetition rate, single frequency, q-switched laser 102 and the signal beam 108 or the idler beam 110 into the anti-reflective coated PPLN optical parametric amplifier (OPA) 116. The filter lens 114 also serves as an optical filter to block either the signal beam 108 or the idler beam 110 generated by the OPG 106. The system 100 is operable to generate narrow linewidth near- and mid-infrared wave with optical efficiency better than 50%. The output wavelength can be fine tuned by tuning the wavelength of the high repetition rate, single frequency q-switched laser 102.

The output wavelength of the PPLN OPG 106 and OPA 116 can be widely tuned by changing the PPLN temperature and different grating periods.

While the system 100 is not limited to any particular single-frequency pulsed light optical pump 102, pump focus lens assembly 104, an optical parametric generator having a nonlinear crystal 106, a filter lens 114, an optical parametric amplifier 116, for sake of clarity a simplified single-frequency pulsed light optical pump 102, pump focus lens assembly 104, an optical parametric generator having a nonlinear crystal 106, a filter lens 114, an optical parametric amplifier 116 are described.

### Apparatus Implementations

In the previous section, a system level overview of the operation of an implementation was described. In this section, the particular apparatus of such an implementation are described by reference to a series of diagrams.

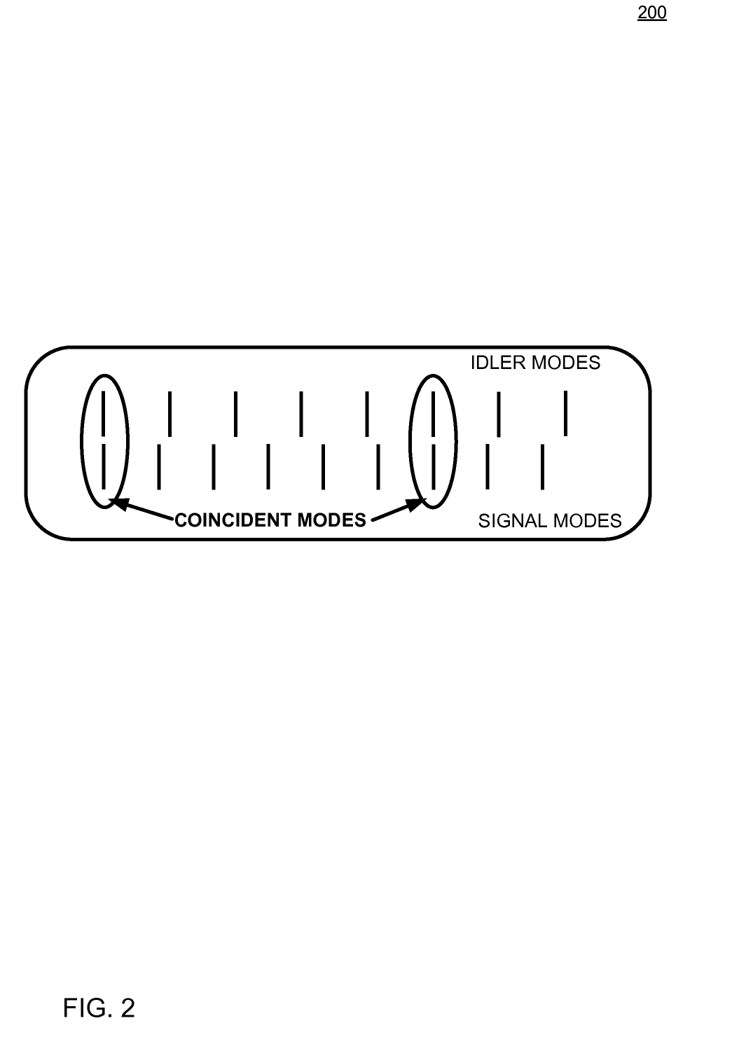

FIG. 2 is a diagram 200 of coincident modes, idler modes and signal modes, according to an implementation.

An OPG with imperfect AR coated parallel surfaces pumped by single frequency, q-switched Nd:YAG laser (50 uJ, 3.5 ns, 5.5 KHz) has a threshold that is reduced by more than 20 dB due to the PPLN surface etalon effect. A very noticeable multiple peak structure is due to the double resonance of the PPLN surfaces which serves as a very low finesse cavity. This is essentially an uncontrolled optical parametric oscillator (OPO). The peak separation is determined by the coincidence of the signal beam (such as signal beam 108 in FIG. 1) and the idler beam (such as idler beam 110 in FIG. 1) resonance condition, show in FIG. 2. The adjacent mode spacing of the signal beam and the idler beam is

$$\frac{C}{2 {n}_{s} L} and \frac{C}{2 {n}_{i} L}$$

respectively. So, the lowest threshold oscillating mode separation is:

$$\frac{C}{2 {n}_{3} L} \frac{\frac{C}{2 {n}_{1} L}}{( \frac{C}{2 {n}_{1} L} - \frac{C}{2 {n}_{3} L} )} = \frac{C}{2 ( {n}_{3} - {n}_{1} ) L}$$

For a 20 cm PPLN crystal, the mode separation is about 4.5 nm. This mechanism effectively creates very strong mode discrimination. This mode selection effect can be used to design a single mode operated OPG.

### Method Implementations

In the previous section, apparatus of the operation of an implementation was described. In this section, the particular methods performed by system 100 of such an implementation are described by reference to a series of flowcharts.

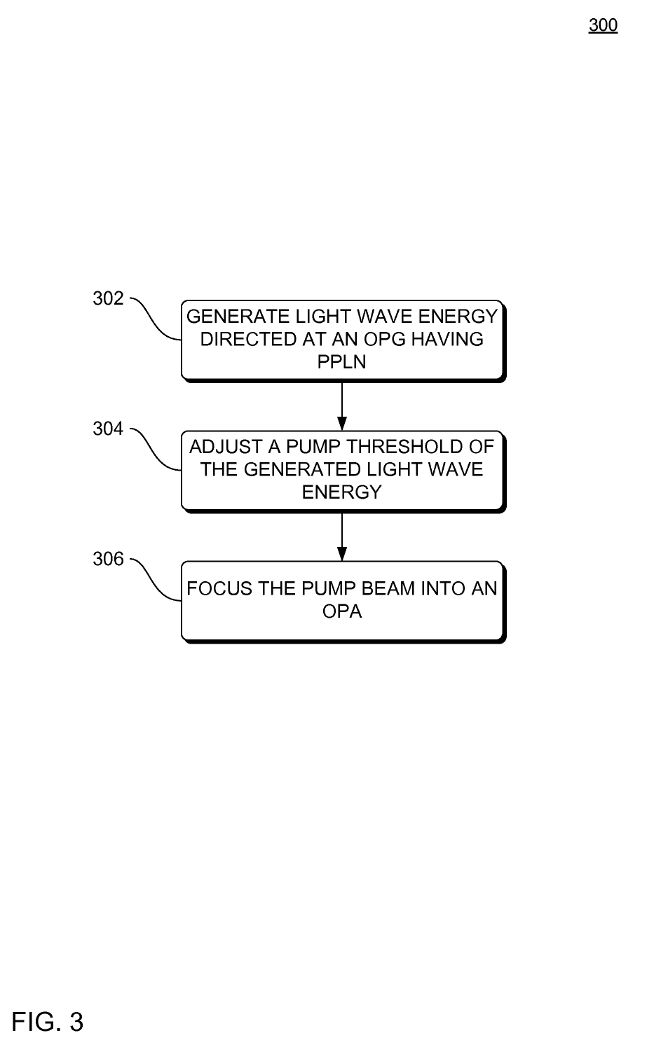

FIG. 3 is a flowchart of a method 300 to generate laser energy, according to an implementation. Method 300 generates narrow linewidth near- and mid-infrared wave with optical efficiency better than 50%.

Method 300 includes generating light wave energy 302, at block 302. The generating is performed by the single-frequency pulsed light optical pump 102 in FIG. 1. The generated light wave energy is directed toward an optical parametric generator (OPG) having periodic poled nonlinear crystal materials, such as PPLN OPG 106 in FIG. 1.

The expression of OPG gain derived by Myers and can be written as

$$G ( L ) = \frac{2 {ω}_{3} {ω}_{1} {d}_{Q}^{2} {I}_{p}}{{n}_{3} {n}_{1} {n}_{p} {s}_{0} {c}^{3}} {L}^{2} sin {c}^{2} ( \frac{Δ {k}_{Q} L}{2} )$$

where ω_{g}, ωᵢ are the angular frequency of the signal and idle waves; d_{Q} is the effective nonlinear coefficient; Iₚ is the pump intensity, η_{g}, ηᵢ, ηₚ are the refraction indexes of the signal beam 108, the idler beam 110 and pump beam 112 respectively. Δk_{Q}, is wave-vector mismatch and L is the length of the PPLN crystal. For sufficient pump pulse energy, OPG gain can be as high as 100,000. Any undesired feedback such as reflection from the PPLN surface could result an uncontrolled oscillation.

Method 300 also includes adjusting a pump threshold of the generated light wave energy, at block 304. The adjusting at block 304 is performed by the pump focus lens assembly 104 of FIG. 1.

The output wavelength of the PPLN OPG 106 can be widely tuned by changing the PPLN temperature and different grating periods. Operation at or near room temperature is therefore often possible without resorting to critical phase matching or non-collinear phase matching. The PPLN OPG 106 generates very narrow line width output just about a threshold of the single-frequency pulsed light optical pump 102.

The periodic poled nonlinear crystal materials of PPLN OPG 106 provide quasi-phase matching of nonlinear interactions of the generated light wave energy in which a periodic reversal of the domain orientation is generated, so that the sign of the nonlinear coefficient also changes. Thus a difference in phase velocity between the pump beam (such as pump beam 112 in FIG. 1) and a harmonic wave of the pump beam that is caused by natural intrinsic dispersion is compensated. In QPM, the pump beam and the harmonic wave of the pump beam are allowed to have different phase velocities, and the pump beam and the harmonic wave of the pump beam will shift π out of phase relative to one another over the coherence length. The sign of the nonlinear coefficient is reversed every coherence length, causing the local generated harmonic field to transfer power to the harmonic beam. By compensating for phase-velocity mismatch in this way, all elements of the crystal's nonlinear tensor can be accessed throughout the entire transparency range.

Method 300 also includes focusing the pump beam and the signal beam (such as signal beam 108 in FIG. 1) or the idler beam (such as idler beam 110 in FIG. 1) into a PPLN OPA, at block 306. The focusing 306 is performed by a filter lens 114 in FIG. 1 that is operably coupled to the nonlinear crystal 106. The PPLN OPA of method 300 is the PPLN OPA 116 in FIG. 1.

Method 300 generates narrow linewidth near- and mid-infrared wave from the PPLN OPA 116 with optical efficiency better than 50%. The output wavelength can be fine tuned by tuning the wavelength of the single-frequency pulsed light optical pump 102.

### CONCLUSION

The systems, methods and apparatus described herein can be implemented in a laser-based gas leak detection devices. A tunable optical parametric generator having periodically poled lithium niobate (PPLN) is described herein. A technical effect of the PPLN being uncoated with parallel faces is wide tunability and strong mode selection. Although specific implementations are illustrated and described herein, it will be appreciated by those of ordinary skill in the art that any arrangement which is calculated to achieve the same purpose may be substituted for the specific implementations shown. This application is intended to cover any adaptations or variations. One of ordinary skill in the art will appreciate that implementations can be made in nonlinear crystal that provides the required function.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to future optical parametric generators, different light pumps, and new nonlinear crystals.

The terminology used in this application meant to include all optical parametric generators, lenses and pumps and alternate technologies which provide the same functionality as described herein.

1. An apparatus comprising:
an optical pump;
a pump focus lens assembly operably coupled to the optical pump;
an optical parametric generator having a nonlinear crystal, the optical parametric generator being operably coupled to the pump focus lens assembly;
a filter lens operably coupled to the optical parametric generator; and
an optical parametric amplifier operably coupled to the filter lens.

2. The apparatus of claim 1, wherein the optical pump further comprises:
a single-frequency pulsed light optical pump.

3. The apparatus of claim 2, wherein the single-frequency pulsed light optical pump further comprises:
a single frequency, Q-switched Nd:YAG laser.

4. The apparatus of claim 1, wherein the nonlinear crystal further comprises:
periodically poled lithium niobate.

5. The apparatus of claim 4, wherein the periodically poled lithium niobate further comprises:
a partially reflective coated periodically poled lithium niobate.

6. The apparatus of claim 5, wherein the partially reflective further comprises:
14% reflection for both a signal beam and an idler beam.

7. The apparatus of claim 4, wherein the periodically poled lithium niobate further comprises:
an uncoated periodically poled lithium niobate.

8. The apparatus of claim 4, wherein the periodically poled lithium niobate further comprises:
periodically poled lithium niobate having parallel polished front faces.

9. The apparatus of claim 1, wherein the optical parametric amplifier further comprises:
periodically poled lithium niobate.

10. The apparatus of claim 9, wherein the periodically poled lithium niobate further comprises:
an anti-reflective coated periodically poled lithium niobate.

10a. The apparatus of claim 10, wherein the periodically poled lithium niobate further comprised:
an end surfaces angle polished periodically poled lithium niobate.

11. An apparatus comprising:
a high repetition rate, single frequency q-switched laser;
an uncoated periodically poled lithium niobate optical parametric generator having a parallel polished surface, the generator being operable to generate very narrow linewidth output just about a threshold of the optical parametric generator, the generator being operably coupled to the laser;
a pump focus lens assembly being operable to adjust the threshold of the optical parametric generator;
an anti-reflective coated periodically poled lithium niobate optical parametric amplifier; and
a filter lens that is operable to focus a beam of the high repetition rate, single frequency, q-switched laser and a signal beam or an idler beam into the optical parametric amplifier.

12. The apparatus of claim 11, wherein the optical parametric generator further comprises:
output wavelength of the optical parametric generator can be tuned by changing the periodically poled lithium niobate temperature and different grating periods.

13. The apparatus of claim 11, wherein the optical parametric generator further comprises:
a length having a range from 5 mm to 20 mm.

14. The apparatus of claim 11, wherein the uncoated front surface of the optical parametric generator further comprises:
a 14% reflection for both a signal beam and an idler beam.

15. A method to generate laser energy, the method comprising:
generating light wave energy by a single-frequency pulsed light optical pump toward an optical parametric generator having periodic poled nonlinear crystal materials;
adjusting a pump threshold of the generated light wave energy, by a pump focus lens assembly; and
focusing the pump beam into an optical parametric amplifier, the optical parametric amplifier having periodic poled nonlinear crystal materials, the focusing being performed by a filter lens.

16. The method of claim 15, the method further comprising:
not including injection seeding.

17. The method of claim 15, wherein the periodic poled nonlinear crystal materials further comprises:
periodically poled lithium niobate.

18. The apparatus of claim 17, wherein the periodically poled lithium niobate further comprises:
an anti-reflective coated periodically poled lithium niobate.

19. The apparatus of claim 17, wherein the periodically poled lithium niobate further comprises:
an uncoated periodically poled lithium niobate.

20. The method of claim 15, wherein the periodic poled nonlinear crystal materials further comprises:
periodic poled nonlinear crystal materials having parallel front faces.

21. The method of claim 15, wherein the periodic poled nonlinear crystal materials further comprises:
periodic poled nonlinear crystal materials having angle polished front faces.
